(19) United States
(12) Patent Application Publication
(10) Pub. No.: US 2015/0088535 A1
(43) Pub. Date: Mar. 26, 2015

(54) MULTIVARIATE COMPUTATIONAL SYSTEM AND METHOD FOR OPTIMAL HEALTHCARE SERVICE PRICING

(71) Applicant: PokitDok, Inc., San Mateo, CA (US)

(72) Inventors: William Bryan Smith, San Mateo, CA (US); Theodore C. Tanner, JR., San Mateo, CA (US)

(73) Assignee: PokitDok, Inc.

(21) Appl. No.: 14/455,341

(22) Filed: Aug. 8, 2014

Related U.S. Application Data
(60) Provisional application No. 61/881,918, filed on Sep. 24, 2013.

(51) Int. Cl. G06Q 50/22; G06Q 40/00

(52) U.S. Cl. CPC G06Q 50/22; G06Q 40/12
USPC 705/2

(57) ABSTRACT

A multivariate computational system and method for optimal healthcare service pricing are disclosed. The system and method may use a computational process that integrates arbitrary sources of healthcare service price and quality information into a model. The model adapts over time such that it determines the optimal price for individual or aggregate healthcare service queries based on regional and temporal adjustments, as well as any of a number of service quality metrics.

### PRIORITY CLAIMS/RELATED APPLICATIONS

This application claims the benefit under 35 USC 119(e) and priority under 35 USC 120 to U.S. Provisional Patent Application Ser. No. 61/881,918, filed Sep. 24, 2013 and titled “A Multivariate Computational System And Method For Optimal Healthcare Service Pricing”, the entirety of which is incorporated herein by reference.

### FIELD

The disclosure relates generally to a system and method for determining optimal healthcare service pricing.

### BACKGROUND

Price setting in the American healthcare service market is currently an opaque process. Specifically, prices for the same service can vary by tens of thousands of dollars from one hospital to another, based on factors that are entirely unknown to the patient, or in many cases even the practicing physician.

Recently, due in part to the Affordable Care Act legislation, there is increasing consumer-driven pressure on healthcare service providers (“providers”) to price their services in a transparent manner, taking into account regional income variability, local demand for the services they provide, and a national ‘baseline’ price, such as that defined by the Center for Medicare Services (CMS). As this pressure increases, and transparency becomes more commonplace, providers who deliver care of a higher quality will find an increased demand for their services, allowing such providers to charge more for their services based on this increased level of quality of care. To date, however, measures of “quality of care” have been hard to come by, and tend to be defined in very limiting terms by the CMS, or in highly general terms by the American Medical Association (AMA).

### BRIEF DESCRIPTION OF THE DRAWINGS

FIG. 1 is a healthcare marketplace system that may incorporate a pricing engine;

FIG. 2 illustrates more details of a pricing engine that uses an adaptive model;

FIG. 3 illustrates a HealthCare Quality Estimation Model of the pricing system;

FIG. 4 illustrate an example of a pricing model of the pricing engine; and

FIG. 5 illustrates an example of a genetic Programming method for Cost Convergence.

### DETAILED DESCRIPTION OF ONE OR MORE EMBODIMENTS

The disclosure is particularly applicable to a web/cloud based healthcare system in which the healthcare service pricing is provided to members of the healthcare system and it is in this context that the disclosure will be described. It will be appreciated, however, that the system and method has greater utility since the healthcare service pricing model may use a different technique than that described below (and those different techniques are within the scope of the disclosure), the pricing engine may provide pricing information to a third party system, the pricing engine may provide the pricing information using a software as service mode and the system and method described below may be implemented in other manners that are within the scope of the disclosure.

The pricing system and method may provide a new model for market clearing dynamics with respect to Health Economic and price equilibrium. For example, the system and method may use a computational process that integrates arbitrary sources of healthcare service price and quality information into a model. The model adapts over time such that the model determines the optimal price for individual or aggregate healthcare service queries based on regional and temporal adjustments, as well as any of a number of service quality metrics. Specifically, since time is the inverse of frequency, the system can easily adapt to a temporal model whereby the number or Frequency (F), as discussed below in more detail, may be a frequency of visits, number of services such as denoted by CPT and or ICD as well as by time stamping the social network comments and reviews. By also incorporating a proprietary, consumer-driven “Request For Quote” (RFQ) methodology, described in co-pending patent application Ser. No. 61/871,195 filed on Aug. 28, 2013 which is incorporated herein by reference, the system and method obtains near real-time feedback from consumers regarding the accuracy of prices established for a given query.

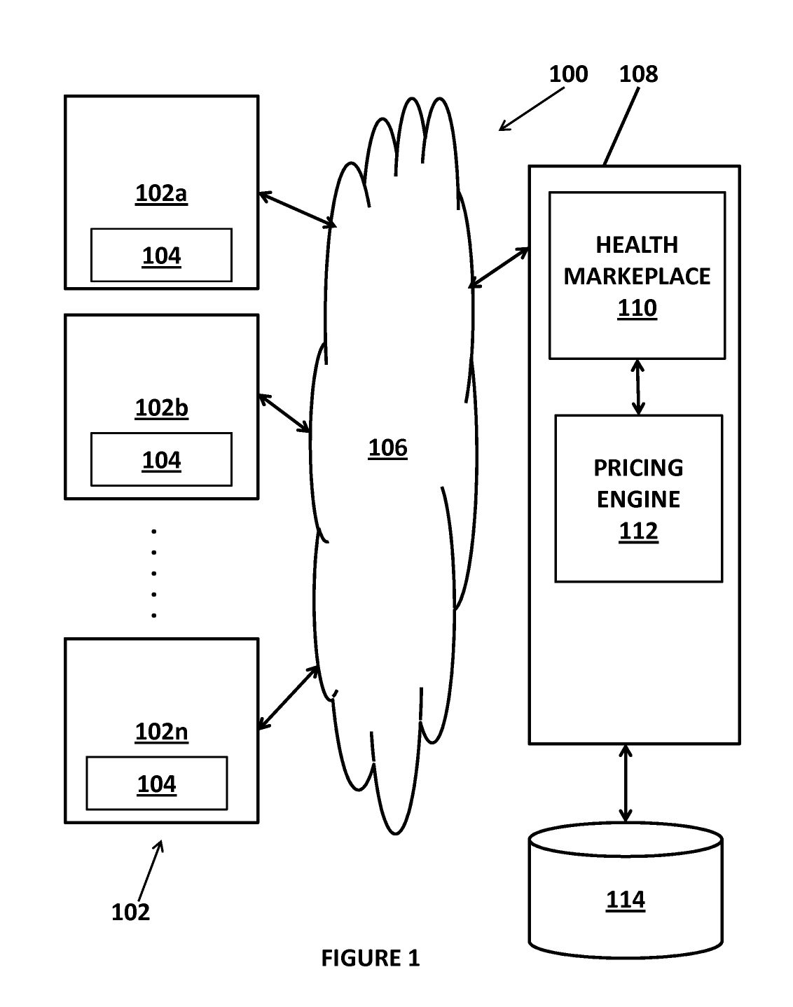

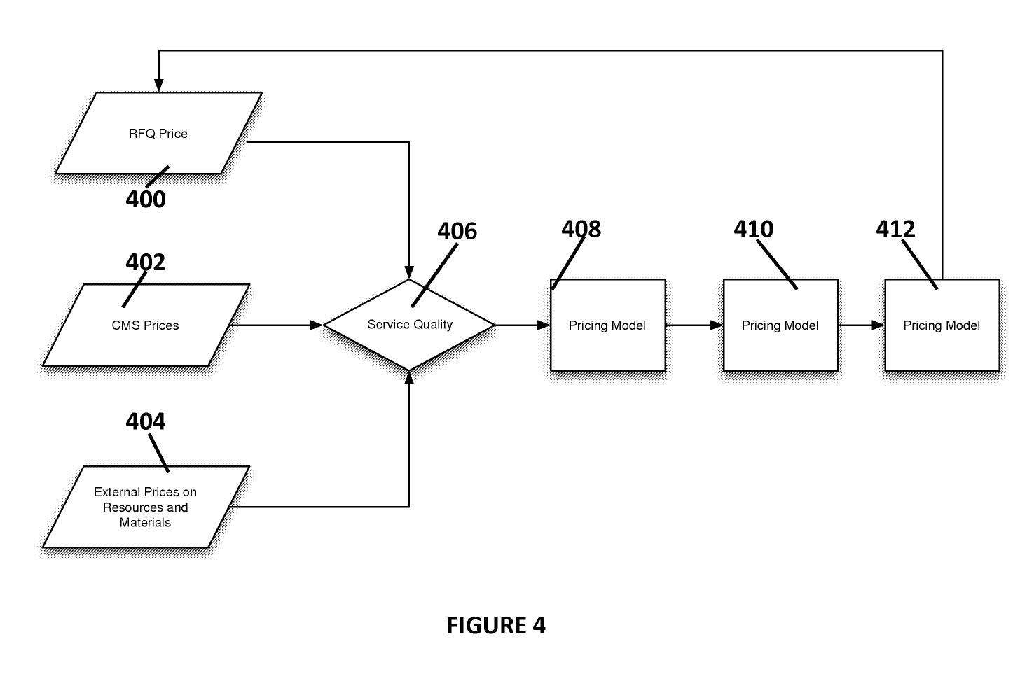

FIG. 1 is a healthcare marketplace system 100 that may incorporate a pricing engine system. The healthcare marketplace system 100 may have one or more computing devices 102 that connect over a communication path 106 to a backend system 108. Each computing device 102, such as computing devices 102a, 102b, . . . , 102n as shown in FIG. 1, may be a processor based device with memory, persistent storage, wired or wireless communication circuits and a display that allows each computing device to connect to and couple over the communication path 106 to a backend system 108. For example, each computing device may be a smartphone device, such as an Apple Computer product, Android OS based product, etc., a tablet computer, a personal computer, a terminal device, a laptop computer and the like. In one embodiment shown in FIG. 1, each computing device 102 may store an application in memory and then execute that application using the processor of the computing device to interface with the backend system. For example, the application may be a typical browser application or may be a mobile application, such as is shown in the example user interfaces in FIGS. 4-7. Each computing device may couple to and communicate with the backend system 108 to submit a request for one or more prices for a particular heathcare service and then receive, from the backend system 108, one or more prices for the particular healthcare service based on the operation of the backend system 108 as described below.

The communication path 104 may be a wired or wireless communication path that uses a secure protocol or an unsecure protocol. For example, the communication path 104 may be the Internet, Ethernet, a wireless data network, a cellular digital data network, a WiFi network and the like.

The backend system 108 may also have a health marketplace engine 110 and a pricing engine 112 that may be coupled together. Each of these components of the backend system may be implemented using one or more computing resources, such as one or more server computers, one or more cloud computing resources and the like. In one embodiment, the health marketplace engine 110 and the pricing engine 112 may each be implemented in software in which each has a plurality of lines of computer code that are executed by a processor of the one or more computing resources of the backend system. In other embodiments, each of the health marketplace engine 110 and the pricing engine 112 may be implemented in hardware such as a programmed logic device, a programmed processor or microcontroller and the like. The backend system 108 may be coupled to a store 114 that stores the various data and software modules that make up the healthcare system. The store 114 may be implemented as a hardware database system, a software database system or any other storage system. In addition to the client/server type architecture shown in FIG. 1, the system may also be implemented on a standalone computer, using a software as a service architecture, implemented within a larger health care provider system and the like.

The health marketplace engine 110 may allow practitioners that have joined the healthcare social community to reach potential clients in ways unimaginable even a few years ago. In addition to giving practitioners a social portal with which to communicate and market themselves with consumers, the marketplace gives each healthcare practitioner the ability to offer their services in an environment that is familiar to users of Groupon, Living Social, or other social marketplaces. The pricing engine 112, in the example shown in FIG. 1 in which the pricing engine 112 is part of the health marketplace system 110, allows a user of the health marketplace system to be provide adaptive pricing for healthcare provider services. Furthermore, the pricing model generated by the pricing engine 112 may be adaptive in that the pricing model may be adjusted based on arbitrary sources of healthcare service price and quality information. For example, additional baseline pricing information may include, but not be limited to: health insurance claims data; federal, state and local government healthcare service agencies in addition to Medicare; price information scraped from websites, etc. Possible additional sources of quality information may include, but not be limited to: customer or peer review data; patient outcomes data; federal, state, and local government healthcare service agencies, etc. These types of data sources may include but are not limited to open source data from the American Medical Association Professional Services Directory, Centers for Medicare and Medicade Services such as http://www.cms.gov/Research-Statistics-Data-and-Systems/Statistics-Trends-and-Reports/Medicare-Provider-Charge-Data/, demographic data such as http://easydbs.com/zipcode-demographics-database, out of pocket costs data such as http://www.fairhealth.org/ and self pay pricing data from the system described in U.S. patent application Ser. No. 14/328,591, filed 7/10/2014, which is incorporated herein by reference.

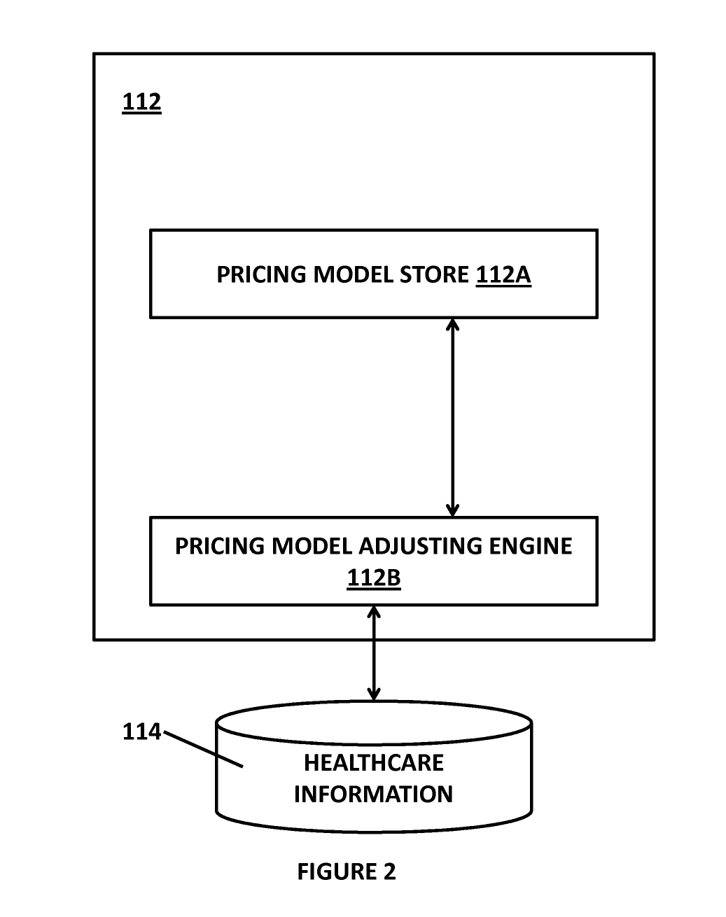

FIG. 2 illustrates more details of a pricing engine 112 that uses an adaptive model and leverages sources of healthcare service price and quality information 114 that may be stored in a store, such as a software or hardware database, that may be collocated with the pricing engine 112 or located remotely from the pricing engine 112. The pricing engine 112 may further include a pricing model store 112A and a pricing model adjusting engine 112B. The pricing model adjusting engine 112B may, based on at least a currently used pricing model stored in the pricing model store 112A and sources of healthcare service price and quality information stored in the store 114, adjust the pricing model. The pricing model store 112A may be implemented using a data structure in a memory of a computing resource on which the healthcare system is executing, a software or hardware database and the like. The pricing model adjusting engine 112B may be implemented in hardware or software. In a software implementation, the pricing model adjusting engine 112B may be a plurality of lines of computer code that may be stored in a computing resource memory and executed by a processor of the computing resource that also implements the healthcare system 108. In a hardware implementation, the pricing model adjusting engine 112B may be a programmed hardware device, a microcontroller with microcode, a memory and the like.

The pricing engine 112 may provide a system and method for optimal healthcare service price setting. The system incorporates available pricing data from any available sources, and integrates these prices with arbitrary measures of healthcare “quality of service” (QOS). The QOS metrics may be direct measures, such as patient outcome information as reported by the CMS, or indirect (or “proxy”) measures of quality as defined by PokitDok or any other entity. An example of how billing code data, as a proxy measure of quality, may be integrated into optimal price setting is described now. For the pricing model, a set of all healthcare providers may be defined as a sparse matrix, S, represented in coordinate form as [Provider Pᵢ, Billing Code Cⱼ, Frequency Fₖ] triples:

S=[Pᵢ,Cⱼ,Fₖ]

where:

i ∈[1, numProviders] for a number of providers, i;
j ∈[1, numCodes] for a number of billing codes, j;
k ∈[0,1]

Thus, for each incidence of the sparse matrix, S, there may be a number of providers and a number of billing codes associated with the providers. Fₖ is the probability that a given provider bills a given CPT for each sevice code and normalized per provider. For example, if a provider, NPI=12345, does two procedures, throat swab and proctology exam, and does 100 throat swabs and 200 proctology exams, that provider would have two entries in the model, which would look like this: [12345, throat_swab_code, 0.333], [12345, procotology_exam_code, 0.667] Further given the above, the system may also calculate the co-currence of the visits and calculate a Probably of visits=Probability(condition I billing_codes) per geo-location which would can also be inferred via the frequency variable F with respect to the CPT services visits.

To place the quality-proxy data in the appropriate context for a pricing model, the system and method may define a score for each provider as a multivariate estimator of provider quality:

scoreᵢ=[efficiencyᵢ,reputationᵢ,legalᵢ]

This allows the pricing system and method to model price as a function of provider quality. Each element of this particular implementation of a score function is described in detail below. Finally, let N represent the set of provider categories as defined in the current (2013) National Provider Identifier (NPI) registry. Then, for all n:

pₙ⊂P; n ∈N

The system and method may employ any suitable classification and regression algorithms to find the maps, xₙ: The system may use various algorithms including Decision Tree Classifiers, Random Forest Trees, Gradient Boosted Trees, Support Vector Machines or Adapative Neural Networks. The types of regression analysis that may be used may include, but not limited to, Linear Regression, Logistic Regression, Generalized Linear Models. These classifiers and regression models are based on the amount of data or the frequency of data is in this case a data driven process.

pₙxₙ=scoreₙ

These maps define how billing code utilization maps to provider quality, within each of the subsets of NPI-defined provider specialties.

Provider Efficiency:

In the billing code model described here, efficiency could be defined as the billing accuracy of each individual provider. This measure takes into account the reimbursement/billing ratio, coding error rates, total provider income, and a variety of other meta parameters related to overall provider quality. As described above, if a provider, NPI=12345, does two procedures, throat swab and proctology exam, and does 100 throat swabs and 200 proctology exams, that provider would have two entries in the model, which would look like this: [12345, throat_swab_code, 0.333], [12345, procotology_exam_code, 0.667]

Provider Reputation:

The PokitDok reputation estimate for providers includes rigorous peer ratings, consumer ratings, board certifications, publications, as well as many other documents that may be indicative of healthcare provider reputation including social media feeds and survey data. For example, given categorical data such as speciality—urology and CPT codes throat swab as 87070, 46600 which are numeric designations are a function of a Current Procedure Terminology (CPT) coding. CPT coding is similar to well-known ICD-9 and ICD-10 coding, except that it identifies the services rendered rather than the diagnosis on the claim. The numbers in the example above are merely illustrative with respect to the example of the vector for the graph formatting.

Provider Legal:

This is modeled as 1—Probability (malpractice), where the probability of malpractice is estimated as an exponential decay from time of last malpractice lawsuit, scaled by total number of malpractice lawsuits filed against a given provider, normalized to the provider's specialty and region of primary practice. For example, the system may calculate the number of revists given the same estimation model given the above parameters and the data is from the American Medical Association including the rate of malpractice as well as data for suspension of the license and or revocation for a particular provider into the following formula:

M(t)=M₀e⁻ⁿ

where M(t)=the frequency of malpractice as at time t, M₀=initial amount at time t=0, r=the decay rate and t=time (number of periods) based on calendar time. Revocation is obviously a binary result where you cannot practice thus immediate null rating.

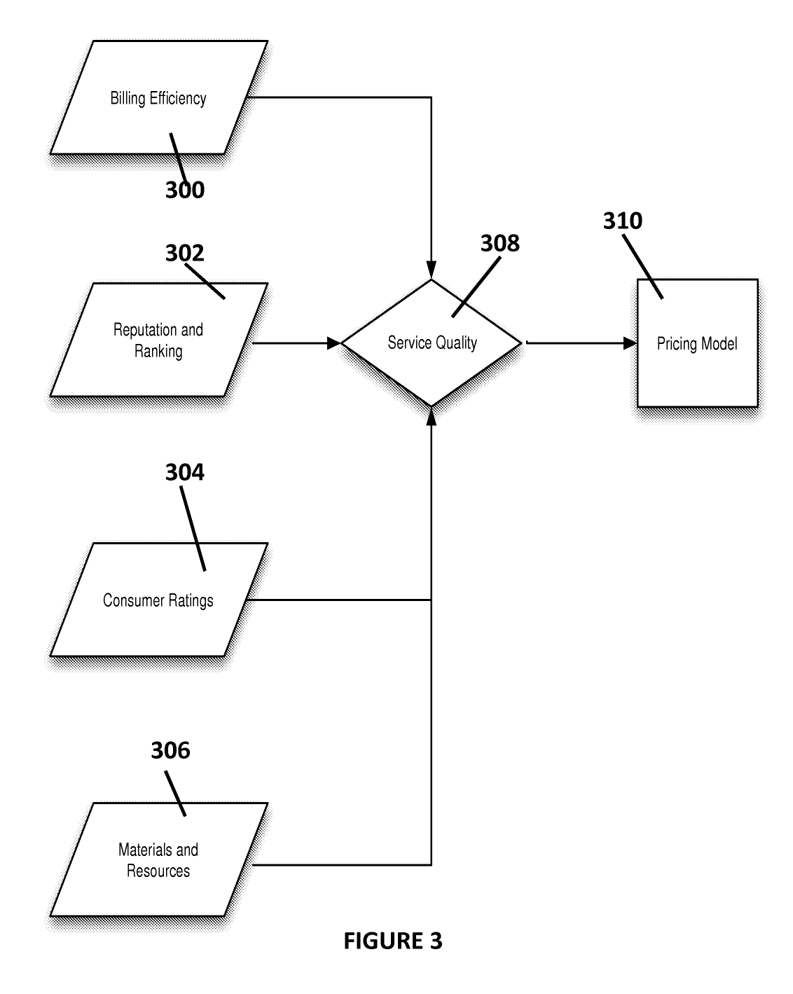

FIG. 3 illustrates a HealthCare Quality Estimation Model 300 of the pricing system. In this model, one or more factors may be used to determine a pricing model for the healthcare service. The one or more factors, grouped together into a vector of numeric values, may include billing efficiency 300 of each provider, a reputation and ranking for each provider 302, a consumer rating for each provider 304 and materials and resources 306. Examples of the consumer ratings and materials may be from Social Media as well as Application Programmer Interfaces (APIs) for data and reviews that can be accessed. For example, the system can refer to http://www.yelp.com/biz/doctors-care-charleston-8 for an example of both consumer numeric and sentiment ratings. Further, Yelp provides access to this information via APIs. Sentiment and “likes” can be used as vector inputs into the consumer quality rating as well. These materials could be but are not limited to fascimiles, office notes, or electronic medical record databases. http://advancingyourhealth.org/highlights/2013/03/30//national-doctors-day-2013-emory-healthcare/ and refer to page 124 for examples of these values http://www.elsevieradvantage.com/samplechapters/9781455707201/Sample%20Chapter.pdf which shows the types of information contained in the Electronic Medical Record (EMR), Electronic Health Record (HER) or Practice Management (PM) systems. This allows deep analysis of repeat visits and patients who would not follow physician directives and change the repeat outcomes coefficients. These one or more factors may be fed into a determination of service quality 308 that may be generated by the pricing model adjusting engine, for example. The service quality 308 may then be used to generate the adaptive pricing model 301 that may then be stored in the pricing model store.

FIG. 4 illustrate an example of a pricing model of the pricing engine. The pricing model may use request for quote prices 400, CMS price 402 and external prices on resources and materials 404 to generate a quality of service measure 406 as shown below in the examples. The quality of service measure 406 may then be used to generate one or more pricing models 408-412 that may adapt depending on the data. In the method, the pricing model price may be fed back to the RFQ price 400 to form a feedback loop of the method.

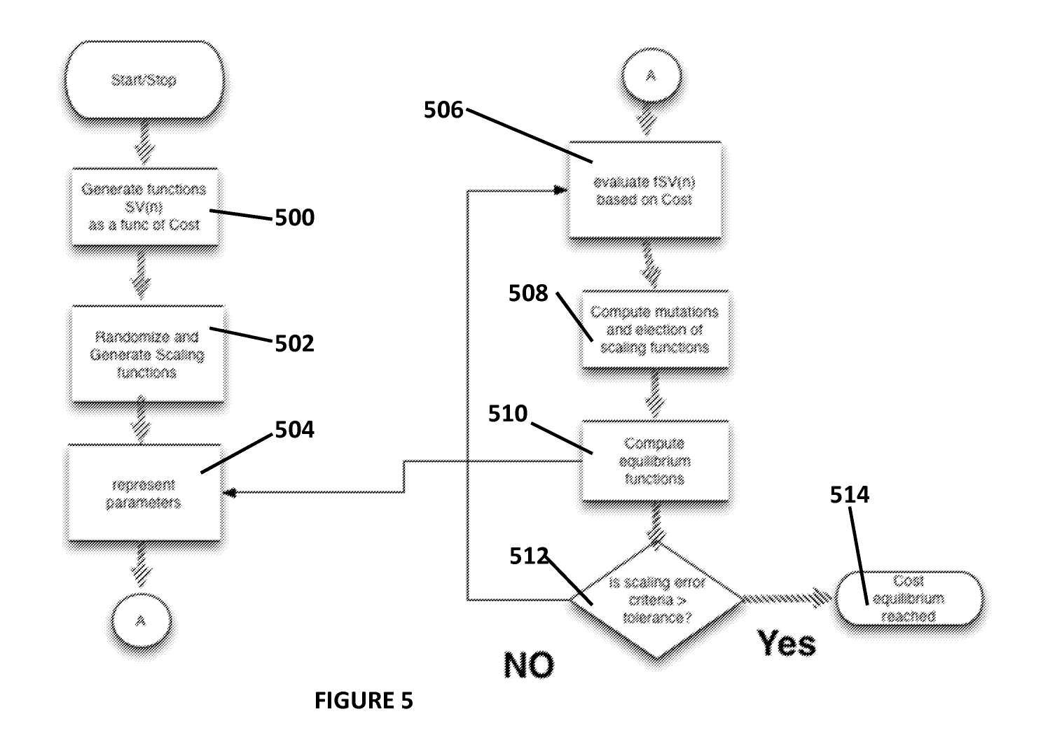

FIG. 5 illustrates an example of a genetic Programming method for Cost Convergence. Specifically, once the parameters of the vectors are selected, the method may apply various scaling functions. These scaling functions as well as additional variables may be used in production implementations. These non-linear scaling function may be, but are not limited to: Logistic, Gamma, and polynomial. These scaling functions are generated as a function of Quality vs Cost. In order to choose the optimal scaling functions, the system and method may utilize a Genetic Evolutionary Programming methodology to converge on the multivariate scaling functions as shown in FIG. 5. We are creating various characteristic functions based on the various equilibrium points between the cost of the service as a function of quality and the requested price from the patient. Due to the multivariate nature of the method and the fact that the genetic programming method converges to a buyer optimality such that each patient maximizes his/her utility subject to their budget constraint based on prior presented information that is contained within our quality metrics.

An example of the step by step process flow may be:

A. User searches for “Knee Surgery”

B. Medicare price for “Lateral Meniscus (Knee) Surgery” in user's geographic region is known to be $2,500.

C. PokitDok “Right Price™” multiplier for “Lateral Meniscus (Knee) Surgery” in user's geographic region is 3× making PokitDok baseline price $7,500.

D. User's geographic region contains 3 surgeons who can perform the procedure: Doctor A has a reputation score in the 50^{th} percentile, an efficiency score in the 50^{th} percentile, and a legal score in the 50^{th} percentile, resulting in a price exactly equal to the PokitDok baseline of $7,500.

E. Doctor B has a reputation score in the 95^{th} percentile, an efficiency score in the 95^{th} percentile, and a legal score in the 95^{th} percentile, resulting in a price of $17,625.

F. Doctor C has a reputation score in the 25^{th} percentile, an efficiency score in the 25^{th} percentile, and a legal score in the 25^{th} percentile, resulting in a price of $3,675.

Below is a simple example of a direct non genetic programmed linear scaling model for pricing where the physician quality scores are assumed to be represented as percentiles (in [0,1]), with the average score being set at 0.50. Other (i.e. nonlinear) scaling functions as well as additional variables may be used in production implementations. These non-linear scaling function can be but are not limited to: Logistic, Gamma, and polynomial.

i) user_geo=PokitDok.get(user_location)

ii) user_query=PokitDok.get(user_search_terms)

iii) geo_scalar=PokitDok.get_geo_scalar(user_query, user_geo)

iv) PokitDok_baseline=average(geo_scalar*[CMS_price, RFQ_price, other_price])

v) PokitDok_Right_Price=PokitDok_baseline *PokitDok.get_Right_Price_scalar(user_query)

vi) physician_quality_vector=[reputation_score, efficiency_score, legal_score]

vii) num_vars=length(physician_quality_vector)

viii) physician_quality_adj=sum((1/num_vars)+(physician_quality_vector−0.5))

ix) PokitDok_Quality_Price=PokitDok_baseline*physician_quality_adj

An example of how this simple model would work with a PokitDok_Right_Price of $2,500 for 3 physicians with scores ranging from average (A) to excellent (B) to poor (C):

scores_A=[0.50, 0.50, 0.50]

PokitDok_Quality_Price_A=2500*(sum ((⅓)+([0,0,0])))=2500*1=$2,500

scores_B=[0.95, 0.95, 0.95]

PokitDok_Quality_Price_B=2500*(sum ((⅓)+([0.45,0.45,0.45])))=2500*2.35=$5,875

scores_C=[0.33, 0.33, 0.33]

PokitDok_Quality_Price_C=2500*(sum ((⅓)+([−0.17, −0.17, −0.17])))=2500*0.49=$1,225

As we can see the “Best” Ranking is not the lowest price. Which is the basis for the multivariate rating system. The advantage herewith is the implicit nature of the rating process.

While the foregoing has been with reference to a particular embodiment of the invention, it will be appreciated by those skilled in the art that changes in this embodiment may be made without departing from the principles and spirit of the disclosure, the scope of which is defined by the appended claims.

1. An apparatus for optimal healthcare service pricing, comprising:
a computer having a processor;
the computer having a pricing model store that is configured to store a plurality of pricing models for a healthcare service; and
the computer having a pricing model adjusting engine that is configured to adjust a pricing model stored in the pricing model store, the pricing model adjusting engine being configured to adjust a pricing model based on one or more external healthcare pricing sources and a quality score of each provider of a particular healthcare service.

2. The apparatus of claim 1, wherein the pricing model adjusting engine is configured to adjust the pricing model using a scaling factor.

3. The apparatus of claim 2, wherein the scaling factor is a non-linear scaling factor.

4. The apparatus of claim 3, wherein the non-linear scaling factor further comprises one of a logistic scaling factor, a gamma scaling factor and a polynomial scaling factor.

5. The apparatus of claim 2, wherein the scaling factor is a linear scaling factor.

6. The apparatus of claim 1, wherein the quality score for each provider further comprises a multivariate estimator of provider quality.

7. The apparatus of claim 6, wherein the quality score for each provider further comprises a provider efficiency score, a provider reputation score and a legal score.

8. The apparatus of claim 1 further comprising a provider store that stores a plurality of providers for the particular healthcare service in a sparse matrix.

9. The apparatus of claim 8, wherein the sparse matrix has a triple for each provider.

10. The apparatus of claim 1 further comprising one or more computing devices, wherein each computing device is configured to interface with the computer to receive one or more pricing estimates for the particular particular healthcare service.

11. The apparatus of claim 1, wherein the one or more external healthcare pricing sources further comprise one of more of health insurance claims data, federal, state and local government healthcare service agencies and price information scraped from websites.

12. The apparatus of claim 1, wherein the one or more external healthcare pricing sources further comprise one of more of customer or peer review data and patient outcome data.

13. A method for optimal healthcare service pricing, comprising:
storing, in a computing having a pricing model store, a plurality of pricing models for a healthcare service;
adjusting, by a pricing model adjusting engine of the computer, a pricing model stored in the pricing model store; and
wherein the pricing model is adjusted based on one or more external healthcare pricing sources and a quality score of each provider of a particular healthcare service.

14. The method of claim 13, wherein adjusting the pricing model further comprises adjusting the pricing model using a scaling factor.

15. The method of claim 14, wherein the scaling factor is a non-linear scaling factor.

16. The method of claim 15, wherein the non-linear scaling factor further comprises one of a logistic scaling factor, a gamma scaling factor and a polynomial scaling factor.

17. The method of claim 14, wherein the scaling factor is a linear scaling factor.

18. The method of claim 13, wherein the quality score for each provider further comprises a multivariate estimator of provider quality.

19. The method of claim 18, wherein the quality score for each provider further comprises a provider efficiency score, a provider reputation score and a legal score.

20. The method of claim 13 further comprising storing a plurality of providers for the particular healthcare service in a sparse matrix.

21. The method of claim 20, wherein the sparse matrix has a triple for each provider.

22. The method of claim 13, wherein the one or more external healthcare pricing sources further comprise one of more of health insurance claims data, federal, state and local government healthcare service agencies and price information scraped from websites.

23. The method of claim 13, wherein the one or more external healthcare pricing sources further comprise one of more of customer or peer review data and patient outcome data.
